(19) United States
(12) Patent Application Publication
(10) Pub. No.: US 2019/0049718 A1
(43) Pub. Date: Feb. 14, 2019

(54) IMAGE INPUT DEVICE AND IMAGE INPUT METHOD

(71) Applicant: OLYMPUS CORPORATION, Tokyo (JP)

(72) Inventor: Shingo KATO, Sagamihara-shi (JP)

(73) Assignee: OLYMPUS CORPORATION, Tokyo (JP)

(21) Appl. No.: 16/162,563

(22) Filed: Oct. 17, 2018

Related U.S. Application Data
(63) Continuation of application No. PCT/JP2016/062794, filed on Apr. 22, 2016.

(51) Int. Cl. G02B 26/10; H04N 1/113; G02B 26/08

(52) U.S. Cl. CPC G02B 26/10; G02B 26/0841; H04N 1/113

(57) ABSTRACT

Provided is an image input device that includes: a scanning unit; a scanning signal obtaining unit; a feature amount detecting unit; an extraction period determining unit; and an image-generating unit that obtains a shift amount between the outward path scanning signal and the return path scanning signal, using the one of the outward path scanning signal and the return path scanning signal in the extraction period and the other of the outward path scanning signal and the return path scanning signal, compensates for the shift between the outward path scanning signal and the return path scanning signal based on the shift amount, and generates an image signal using the shift-compensated outward path scanning signal and return path scanning signal.

### CROSS REFERENCE TO RELATED APPLICATIONS

This application is a continuation application based on a PCT Patent Application No. PCT/JP2016/062794, filed on Apr. 22, 2016, the entire content of which is hereby incorporated by reference.

### BACKGROUND

### Technical Field

The present invention relates to an image input device and an image input method.

### Background Art

There is an image input device in which a laser beam is projected onto a sample via a MEMS (Micro-Electro-Mechanical System) mirror or a galvanometer mirror which makes a resonant motion, and the reflected light from the sample is reflected again via the mirror and obtained. The image input device generates an image signal based on a scanning signal obtained by photoelectric conversion of reflected light received from the sample.

The image input device includes an induced electromotive voltage signal detection circuit and a feedback circuit. The induced electromotive voltage signal detection circuit detects an induced electromotive voltage generated in the driving coil of the mirror. The feedback circuit includes a feedback circuit for adjusting a phase difference between a zero-cross signal obtained by zero-crossing the detected induced electromotive voltage and a driving pulse signal for driving the driving coil. The feedback circuit adjusts the phase of the zero-cross signal and the driving pulse signal to the phase of the zero-cross signal based on the phase difference. As a result, the drive frequency approaches the resonance frequency of the mirror, so that the mirror resonates.

When the mirror resonates, the position where the light from the mirror incident on the specimen is reflected reciprocates. The image input device receives reflected light from a position reciprocating on the sample and photoelectrically converts the received reflected light to obtain a scanning signal. On the other hand, induced electromotive voltage is generated in the driving coil by the change in the magnetic flux caused by the motion of the mirror. A zero-cross signal zero-crossed is obtained from the voltage value of the induced electromotive voltage generated. The obtained zero-cross signal has a high voltage signal period (hereinafter referred to as Hi signal period) in which the voltage value is higher than a predetermined voltage value and a low voltage signal period (hereinafter referred to as Low signal period). Each of the scanning signals within the Hi signal period and the Low signal period is classified as an outward path scanning signal and a return path scanning signal. Then, the image input device reads the return path scanning signal with the reading direction opposite to the direction of the outward path scanning signal, sequentially integrates each outward path scanning signal and the subsequent return path scanning signal read in the reverse direction to generate an image signal of one frame.

On the other hand, when adjusting the input size of the image, the image input device controls the swing angle of the mirror by changing the voltage of the driving pulse supplied to the driving coil of the mirror. When adjusting the input size of an image under such a configuration, if the driving pulse voltage is changed, the resonance frequency of the mirror also varies. The feedback circuit adjusts the drive frequency so as to be equal to the resonance frequency of the mirror, but the swing angle of the mirror and the phase of the induced electromotive voltage from the induced electromotive voltage detection circuit change depending on individuals, temperature, and the like. These changes cause an error between the swing angle of the mirror and the phase of the induced electromotive voltage, and eventually become a factor of fluctuation of the resonance frequency.

Here, it is assumed that only one of the outward path scanning signal and the return path scanning signal is employed to generate an image signal. In this case, phase errors cause image shifts. Image shift is a phenomenon in which the position of the image indicated by the generated image signal is biased toward one side as a whole. Therefore, image shift does not cause deterioration of image quality. However, it is not possible to obtain the advantages of reciprocating scanning such as improvement of resolution under a certain scanning time, shortening of scanning time with a fixed resolution. On the other hand, if an image signal is generated using both the outward path scanning signal and the return path scanning signal, a shift occurs between each line between the outward path scanning signal and the following return path scanning signal, resulting in image quality degradation.

Therefore, in the optical scanning type image input device described in Japanese Unexamined Patent Application, First Publication No. H8-32768, the vertical stripe test pattern is used as the calibration sample, and the shift amount between the outward path scanning signal and the return path scanning signal obtained by operating in the calibration mode is detected. Then, the optical scanning image input device sets the detected shift amount in the register, and compensates the shift between the outward path scanning signal and the return path scanning signal obtained by using the target sample using this register.

### SUMMARY

An image input device includes: a scanning unit that moves a scanning point, which is a point where light from a light source is incident on a surface of a sample, in a reciprocating manner, and outputs a scanning period end signal that represents ending of a reciprocating scanning period; a scanning signal obtaining unit that obtains an outward path scanning signal that represents an intensity of light reflected from the scanning point along an outward path, and a return path scanning signal that represents an intensity of light reflected from the scanning point along a return path; a feature amount detecting unit that detects a feature amount that represents an amount of a high-frequency component which is a component whose frequency is higher than a predetermined frequency from one of the outward path scanning signal and the return path scanning signal; an extraction period determining unit that determines an extraction period in which an amount of the high-frequency component indicated by the feature amount is larger than a predetermined amount; and an image-generating unit that obtains a shift amount between the outward path scanning signal and the return path scanning signal, using the one of the outward path scanning signal and the return path scanning signal in the extraction period and the other of the outward path scanning signal and the return path scanning signal, compensates for a shift between the outward path scanning signal and the return path scanning signal, based on the shift amount, and generates an image signal using the outward path scanning signal and return path scanning signal that have been shift-compensated.

The image input device may further include: a period classification unit that determines a low speed period in which a scanning speed is lower than a predetermined scanning speed, wherein the image-generating unit may calculate a shift amount between the outward path scanning signal and the return path scanning signal in the low speed period.

The period classification unit may determine a high speed period in which the scanning speed is higher than a predetermined scanning speed, and the image-generating unit may determine a search range based on the shift amount in the low speed period and obtain the shift amount between the outward path scanning signal and the return path scanning signal in the high speed period within the search range.

An image input method in an image input device includes: a scanning process in which a scanning point, which is a point where light from a light source is incident on a surface of a sample, is moved in a reciprocating manner, and a scanning period end signal that represents ending of a reciprocating scanning period is output; a scanning signal obtaining process in which an outward path scanning signal that represents an intensity of light reflected from the scanning point along an outward path, and a return path scanning signal that represents an intensity of light reflected from the scanning point along a return path are obtained; a feature amount detecting unit that detects a feature amount from one of the outward path scanning signal and the return path scanning signal, the feature amount representing an amount of a high-frequency component which is a component whose frequency is higher than a predetermined frequency; a period determination process in which a period in which an amount of the high-frequency component indicated by the feature amount is larger than a predetermined amount is determined; and an image-generating process in which a shift amount between the outward path scanning signal and the return path scanning signal is obtained, using the one of the outward path scanning signal and the return path scanning signal in the period and the other of the outward path scanning signal and the return path scanning signal, a shift between the outward path scanning signal and the return path scanning signal is compensated for, based on the shift amount, and an image signal is generated, using the outward path scanning signal and return path scanning signal that have been shift-compensated.

### BRIEF DESCRIPTION OF THE DRAWINGS

FIG. 1 is a schematic block diagram showing a configuration example of an image input device according to a first embodiment.

FIG. 2 is a schematic block diagram showing a configuration example of a drive circuit according to a first embodiment.

FIG. 3 is a schematic block diagram showing a configuration example of an image input device according to a second embodiment.

FIG. 4 is a diagram showing an example of an image based on a scanning signal.

FIG. 5 is a diagram showing an example of an image based on an HPF signal.

FIG. 6 is a diagram showing an example of a selected block.

FIG. 7 is a diagram showing an example of an image represented by an image signal subjected to shift compensation.

FIG. 8 is a diagram showing an example of a scanning signal and an induced electromotive voltage signal.

FIG. 9 is a schematic block diagram showing a configuration example of an image input device according to a third embodiment.

FIG. 10 is a schematic block diagram showing a configuration example of an image input device according to a fourth embodiment.

FIG. 11 is a flowchart showing a shift detection process according to a fourth embodiment.

### DETAILED DESCRIPTION OF THE PREFERRED EMBODIMENTS

Hereinafter, an image input device according to an embodiment of the present invention will be described with reference to the drawings.

### First Embodiment

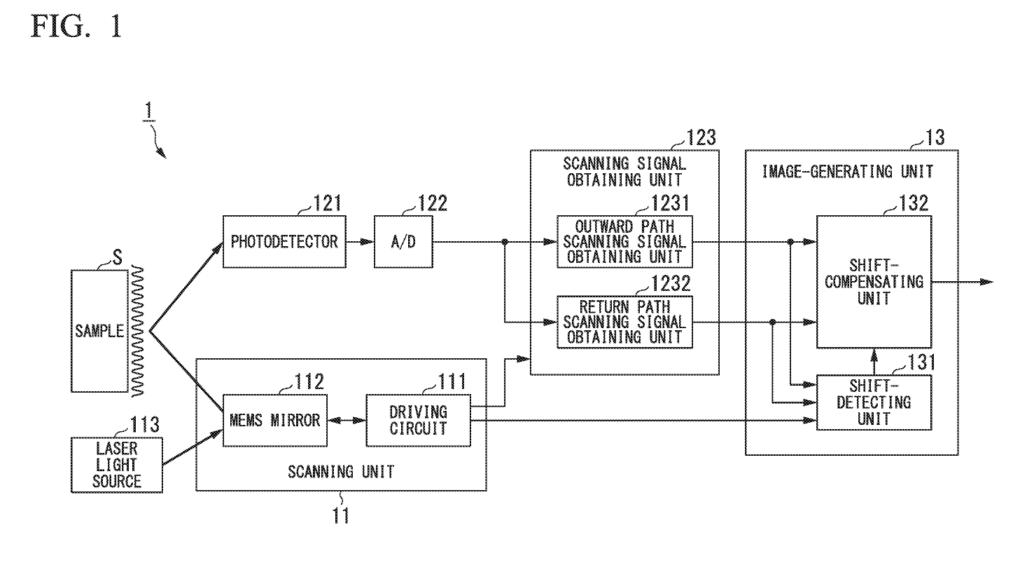

FIG. 1 is a schematic block diagram showing a configuration example of an image input device 1 according to a first embodiment of the present invention.

The image input device 1 includes a scanning unit 11, a laser light source 113, a photodetector 121, an A/D 122, a scanning signal obtaining unit 123, and an image-generating unit 13.

The scanning unit 11 includes a driving circuit 111 and a MEMS mirror 112.

The driving circuit 111 generates a scanning period end signal and a driving pulse signal. The scanning period end signal is a pulse signal indicating the end of each reciprocating scanning period of the MEMS mirror 112. The driving circuit 111 outputs the generated scanning period end signal to the shift-detecting unit 131 of the image-generating unit 13. The driving pulse signal is a pulse signal for driving the MEMS mirror 112. The drive circuit 111 outputs the generated driving pulse signal to a driving coil (not shown) integrally mounted on the MEMS mirror 112. A driving pulse signal is input to the driving coil from the drive circuit 111. Further, a permanent magnet (not shown) is disposed on the support portion (not shown) of the MEMS mirror 112. A Lorentz force is generated in the driving coil that receives the magnetic field generated by the permanent magnet by the current due to the driving pulse signal. The MEMS mirror 112 is driven together with the driving coil by the generated Lorentz force.

The magnetic flux from the permanent magnet passing through the driving coil fluctuates with vibration. As the magnetic flux changes, induced electromotive voltage is generated in the driving coil. The induced electromotive voltage generated is applied to the drive circuit 111. The drive circuit 111 controls the cycle of the driving pulse signal and the scanning period end signal so as to approach the period of the induced electromotive voltage. Further, by setting the period of the driving pulse signal to a period within a predetermined range from the resonance period of the MEMS mirror 112, the MEMS mirror 112 resonates. The configuration of the drive circuit 111 will be described later.

The MEMS mirror 112 reflects light rays coming from the laser light source 113. Reflected light from the MEMS mirror 112 is projected on the surface of the sample S. As described above, the MEMS mirror 112 is installed integrally with the driving coil within the magnetic field generated by the permanent magnet. With this configuration, it is possible to vibrate the direction of the reflecting surface that reflects the light beam. Due to this vibration, the scanning point, which is the position where the reflected light is incident on the sample S, is reciprocated. Therefore, the scanning unit 11 is able to cause the photodetector 121 to receive the reflected light from the scanning point while reciprocating the scanning point at which the light beam is incident on the surface of the sample S. As a result, an image representing the state of the surface of the sample S is scanned. In the following description, the path of the scanning point moving in a predetermined direction or the vibration of the MEMS mirror 112 that moves the scanning point in one direction is called the outward path. Also, the vibration of the MEMS mirror 112 that moves the scanning point in the direction in which the scanning point moves in the opposite direction to the one direction or in the opposite direction is called a return path. For example, the moving direction of the scanning point of the first line on the sample S may be defined as the direction of the outward path. In that case, the outward path scanning signal and the return path scanning signal obtained by the outward scanning and the return scanning respectively represent an odd line image and an even line image.

The swing angle and the vibration period of the MEMS mirror 112 are controlled by the intensity and cycle of the driving pulse signal input from the drive circuit 111. The swing angle is an angle formed by the direction of the reflection surface at that time and the direction of the reflecting surface in the stationary state. The period of the driving pulse signal is controlled so as to approach the resonance period of the MEMS mirror 112 in the drive circuit 111. Therefore, the MEMS mirror 112 performs a resonant motion. By performing the resonant motion of the MEMS mirror 112, it is possible to efficiently scan the image of the surface of the sample S.

Reflected light reflected at the projection point on the surface of the sample S is incident on the photodetector 121. The photodetector 121 is a photodetecting unit that photoelectrically converts the incident reflected light to generate a scanning signal. The photodetector 121 outputs the generated scanning signal to the A/D 122.

An A/D (Analog-to-Digital Converter) 122 performs A/D conversion on the analog scanning signal input from the photodetector 121, and generates a digital scanning signal. The A/D 122 outputs the generated digital scanning signal to the scanning signal obtaining unit 123.

The scanning signal obtaining unit 123 obtains a scanning signal from the A/D 122. The scanning signal obtaining unit 123 includes an outward path scanning signal obtaining unit 1231 and a return path scanning signal obtaining unit 1232.

The outward path scanning signal obtaining unit 1231 obtains the outward path scanning signal from the scanning signal input from the A/D 122. The outward path scanning signal is a scanning signal obtained within the outward path period which is a period during which the scan point moves on the outward path. The outward path scanning signal obtaining unit 1231 includes a first-in first-out (FIFO) memory as a storage unit for temporarily storing the outward path scanning signal obtained for each outward path. The outward path scanning signals stored in the FIFO memory are read out in the same order as the stored order.

The return path scanning signal obtaining unit 1232 obtains the return path scanning signal from the scanning signal from the A/D 122. The return path scanning signal is a scanning signal obtained within the return path period, which is a period during which the scanning point moves on the return path. The return path scanning signal obtaining unit 1232 includes a LIFO (Last-in First-out) memory as a storage unit that temporarily stores the return path scanning signal obtained for each return path. The return path scanning signals stored in the LIFO memory are read out in reverse order to the order in which they are stored. Therefore, the direction of the return path scanning signal read from the LIFO memory is the same direction as the scanning direction of the outward path scanning signal.

Based on the voltage value of the zero-cross signal (described later) input from the drive circuit 111, The outward path scanning signal obtaining unit 1231 is able to identify the outward period and the return path scanning signal obtaining unit 1232 is able to identify the return period.

The Image generating unit 13 includes a shift-detecting unit 131 and a shift-compensating unit 132.

When the scanning period end signal is input from the driving circuit 111, the shift-detecting unit 131 reads the outward path scanning signal and the return path scanning signal from the outward path scanning signal obtaining unit 1231 and the return path scanning signal obtaining unit 1232, respectively. The shift-detecting unit 131 performs block matching on the outward path scanning signal and the return path scanning signal that have been read out. Block matching is a process of obtaining the shift amount in which both signals are most similar to each other between one signal and the other signal shifted in position. Specifically, the shift-detecting unit 131 calculates an index value indicating the similarity between the outward path scanning signal and the return path scanning signal shifted in position by each of a plurality of shift amount candidates. The shift amount candidate means a candidate of a shift amount.

The shift-detecting unit 131 determines shift amount candidates that provide the index value having the highest similarity as the shift amount between the outward path scanning signal and the return path scanning signal. The index value is, for example, SAD (Sum of Absolute Differences). The SAD is an index value indicating that the smaller the value is, the higher the similarity is. In this manner, the shift-detecting unit 131 starts detecting the shift amount based on the outward path scanning signal and the return path scanning signal read out in response to the input of the scanning period end signal. Therefore, the shift-detecting unit 131 is able to sequentially detect the shift amount for each reciprocating scan.

In general, the block matching may mean a process of determining a two-dimensional shift amount based on the similarity between images in which a plurality of pixels are two-dimensionally arranged. However, in the present embodiment, each of a plurality of shift amount candidates is a one-dimensional value within a search range of a predetermined shift amount. The shift amount candidate is, for example, a pixel unit value which can be a positive value or a negative value.

It should be noted that the shift-detecting unit 131 is not limited to SAD as an index value indicating similarity between the two types of signals, and other index values such as SSD (Sum of Squared Differences), for example, can also be used.

It should be noted that the shift-detecting unit 131 may include a subpixel calculation circuit that applies the index value calculated for each shift amount candidate to a predetermined fitting function in the block matching, and calculates the shift amount candidate indicating that the index value interpolated by the fitted function is the most similar. The calculated shift amount candidate may have a precision of a unit smaller than one pixel (hereinafter referred to as a subpixel unit) as a shift amount between the outward path scanning signal and the return path scanning signal. For example, the fitting function is a quadratic function with respect to the shift amount candidate. When SAD is used as the index value, the quadratic function is a downwardly convex function. In the fitting of the function, for example, a regression analysis method such as a least squares method can be used. The shift-detecting unit 131 outputs a shift amount signal indicating the determined shift amount to the shift-compensating unit 132.

In the case where the shift-detecting unit 131 determines the shift amount in the subpixel unit, the A/D 122 may include a delay circuit for delaying the sampling clock generated when A/D conversion is performed in one of the outward path scanning signal and the return path scanning signal by the delay amount corresponding to the shift amount. As a result, the scanning signal obtaining unit 123 obtains the outward path scanning signal and the return path scanning signal whose shift amount has been compensated in a subpixel unit. The scanning signal obtaining unit 123 outputs the obtained outward path scanning signal and return path scanning signal to the image-generating unit 13.

As described above, the block matching processing unit executed by the shift-detecting unit 131 is not limited to one reciprocating scanning. The processing unit of the block matching may be, for example, a predetermined number of reciprocating scans, one frame, or the like. When the processing unit of block matching is one frame, the number of lines per frame is set not only for the shift-compensating unit 132 but also in the shift-detecting unit 131 according to the resolution and the size in the vertical direction of the image. In the case where the processing unit of block matching is a reciprocating scanning of a plurality of times, the outward path scanning signal obtaining unit 1231 and the return path scanning signal obtaining unit 1232 include a FIFO memory and a LIFO memory that can store the outward path scanning signal and the return path scanning signal related to the number of times of scanning respectively. The return path scanning signal obtaining unit 1232 includes a plurality of LIFO memories so that the reading order of the return path scanning signal is set for each one scanning. In each LIFO memory, a return path scanning signal for each line is stored.

The shift-compensating unit 132 compensates so as to offset the shift between the outward path scanning signal and the return path scanning signal based on the shift amount indicated by the shift amount signal input from the shift detecting unit 131. The shift-compensating unit 132 includes, for example, a delay circuit that shifts the outward path scanning signal or the return path scanning signal with a delay amount corresponding to the shift amount. Here, a case where the shift amount is a shift amount of the return path scanning signal obtained with the outward path scanning signal as a reference is taken as an example. When the shift amount is a positive value, the delay circuit delays the outward path scanning signal with a delay amount corresponding to the shift amount, and when the shift amount is a negative value, the delay circuit delays the return path scanning signal with a delay amount corresponding to the absolute value of the shift amount. When the shift amount is determined in units of pixels, the delay circuit has a configuration that shifts the read address when reading the scanning signal delayed by the pixel unit. When the shift amount is determined in subpixel units, the delay circuit performs interpolation calculation on the signal value of each pixel indicated by the scanning signal, and outputs the signal value of each pixel delayed according to the shift amount.

It should be noted that the shift-compensating unit 132 may compensate the shift for each unit equal to the processing unit of the block matching. For example, when block matching is performed for each round of reciprocating scanning, the shift-compensating unit 132 compensates the shift for each round of reciprocating scanning. The shift-compensating unit 132 sequentially integrates the outward path scanning signal and the return path scanning signal that have been compensated for each reciprocating scan to form an image signal of each frame. The shift-compensating unit 132 outputs the formed image signal to the outside of the image input device 1.

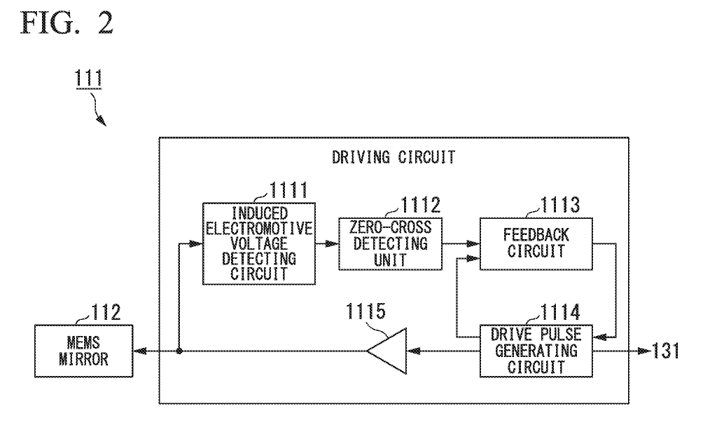

Next, the configuration of the drive circuit 111 according to the present embodiment will be described. FIG. 2 is a schematic block diagram showing a configuration example of the drive circuit 111 according to the present embodiment.

The drive circuit 111 includes an induced electromotive voltage detecting circuit 1111, a zero-cross detecting unit 1112, a feedback circuit 1113, a driving pulse generating circuit 1114, and an amplifier 1115.

The induced electromotive voltage detecting circuit 1111 detects the induced electromotive voltage applied from the driving coil. The induced electromotive voltage detecting circuit 1111 generates an induced electromotive voltage signal indicating the induced electromotive voltage applied and outputs the generated induced electromotive voltage signal to the zero-cross detecting unit 1112.

The zero-cross detecting unit 1112 detects the zero-cross point of the voltage value indicated by the induced electromotive voltage signal input from the induced electromotive voltage detecting circuit 1111, and generates a zero-cross signal based on the detected zero-cross point. The zero-cross signal is a signal in which the voltage value of the induced electromotive voltage signal is Hi and Low, respectively, during periods when the voltage value of the induced electromotive voltage signal is higher than 0 and lower than 0. Hi and Low are preset voltage values, respectively. However, Hi is a voltage value significantly higher than Low. The zero-cross detecting unit 1112 outputs the generated zero-cross signal to the feedback circuit 1113.

The induced electromotive voltage generated in the driving coil according to the vibration corresponds to the first differentiation of the swing angle of the MEMS mirror 112 with respect to time, that is, the angular velocity of the vibration. Therefore, the Hi signal period in which the voltage value of the zero-cross signal is Hi and the Low signal period in which the voltage value of the zero-cross signal is Low indicate the outward period during which the scanning speed is positive and the return period in which the scanning speed is negative, respectively. The scanning speed means the moving speed of the scanning point.

To the feedback circuit 1113, a sampling reset signal from the driving pulse generating circuit 1114 and a zero-cross signal from the zero-cross detecting unit 1112 are input. The feedback circuit 1113 adjusts the phase of the sampling clock signal generated by its own part based on the sampling reset signal and the zero-cross signal. The sampling reset signal is a pulse signal having a predetermined voltage value at every predetermined scanning period in the driving pulse generating circuit 1114 as described later. The period and phase of the sampling reset signal are equal to the period and phase of the driving pulse signal respectively. Therefore, the feedback circuit 1113 adjusts the phase of the sampling clock signal generated by its own part so that the phase difference between the input sampling reset signal and the zero-cross signal approaches zero. Therefore, the phase of the driving pulse signal is adjusted so as to approach the phase of the induced electromotive voltage generated by the driving coil.

Note that the feedback circuit 1113 may adjust the shift between the outward path scanning signal and the return path scanning signal by delaying the input zero-cross signal with a delay amount corresponding to the shift amount detected by the shift detecting unit 131. The case where the shift amount is a shift amount of the return path scanning signal obtained with the outward path scanning signal as a reference is taken as an example. When the shift amount is a positive value, the feedback circuit 1113 delays the start time of the Hi signal period with a delay amount corresponding to the shift amount. When the shift amount is a negative value, the feedback circuit 1113 delays the start time of the Low signal period with a delay amount corresponding to the absolute value of the shift amount.

The feedback circuit 1113 is, for example, a PLL (Phase Locked Loop, Phase Locked Circuit). The PLL is configured to include a PD (Phase Detecting unit), LPF (Low-Pass Filter) and VCO (Voltage Control Oscillator).

The PD is a circuit that converts the phase difference between the two input signals into a voltage and outputs the converted voltage as a phase difference signal. When the PLL is an analog PLL, for example, an analog multiplier is used as the PD. When the PLL is a digital PLL, for example, the PD includes an exclusive OR circuit, a charge pump, and the like. In the present embodiment, the PD outputs a phase difference signal representing the phase difference between the zero-cross signal from the zero-cross detecting unit 1112 and the induced electromotive voltage from the driving coil to the LPF.

The LPF passes through a component having a frequency lower than a predetermined cutoff frequency among components of each frequency of the phase difference signal input from the PD and outputs a phase difference signal composed of the passed component to the VCO. This avoids oscillation due to amplification of temporary short-cycle voltage fluctuations that may occur.

The VCO generates a sampling clock signal having a frequency corresponding to the voltage of the phase difference signal input from the LPF. As the voltage of the input phase difference signal is higher, a sampling clock signal having a higher frequency is generated. The VCO is configured to include, for example, a variable capacitance diode. The parameters of the circuit elements constituting the VCO are preset so that the period of the sampling clock signal given according to the phase difference signal corresponds to the scanning period of each pixel. The VCO outputs the generated sampling clock signal to the driving pulse generating circuit 1114.

The driving pulse generating circuit 1114 generates a driving pulse signal, a scanning period end signal, and a sampling reset signal based on the sampling clock signal input from the feedback circuit 1113. The driving pulse signal, the scanning period end signal, and the sampling reset signal are pulse signals having a common scanning period and phase. The scanning period is a cycle of oscillating the MEMS mirror 112 installed in the driving coil, that is, a cycle of one reciprocating for scanning the image on the sample S.

The driving pulse signal is a signal having a predetermined positive voltage value and negative voltage value, for example, in a ¼ period and a ¾ period from the start time of each scanning period. The scanning period end signal and the sampling reset signal are each a signal having a predetermined positive voltage value at the end time of each scanning period. The scanning period corresponds to a period obtained by multiplying the period of the sampling clock signal by the number of pixels per scan of one reciprocating movement. Hereinafter, the number of pixels per reciprocating scan is referred to as the number of scanning pixels. The number of scanning pixels is set in the driving pulse generating circuit 1114 according to the resolution and the horizontal size of the image. The horizontal size of the image depends on the maximum swing angle of the MEMS mirror 112. The driving pulse generating circuit 1114 outputs the generated driving pulse signal to the amplifier 1115, and outputs the scanning period end signal to the shift-detecting unit 131.

The driving pulse generating circuit 1114 includes, for example, a driving system counter, a sampling system counter, and three comparators. Hereinafter, three comparators are referred to as comparators 1, 2, and 3, respectively, and are distinguished from each other. The driving system counter sequentially counts the cycle of the sampling clock signal input from the feedback circuit 1113. The driving system counter outputs the count value at that time obtained by counting to each of the comparators 1, 2, and 3. To the driving system counter, a scanning period end signal is input as a reset signal from the comparator 3. The driving system counter resets the count value to 0 when the scanning period end signal is input.

The comparator 1 generates a driving pulse signal having a predetermined positive voltage value when the count value input from the driving system counter is equal to the number of pixels corresponding to ¼ period of the scanning period. The comparator 1 outputs the generated driving pulse signal to the amplifier 1115.

The comparator 2 generates a driving pulse signal having a predetermined negative voltage value when the count value input from the driving system counter is equal to the number of pixels corresponding to ¾ cycle of the scanning period. The comparator 2 outputs the generated driving pulse signal to the amplifier 1115.

The comparator 3 generates a scanning period end signal having a predetermined voltage value when the count value input from the driving system counter is equal to the number of pixels corresponding to the end time of the scanning cycle. The comparator 3 outputs the generated scanning period end signal to the shift-detecting unit 131 and the driving system counter.

The number of scanning pixels may be variable according to the set resolution and maximum swing angle. For example, when the number of scanning pixels is 4000 pixels, the number of pixels when the number of scanning pixels corresponds to a ¼ cycle of the scanning cycle, the number of pixels when the number of scanning pixels corresponds to ¾ cycle of the scanning cycle, and the number of pixels when the number of scanning pixels corresponds to the end time of the scanning cycle are 1000 pixels, 3000 pixels, and 4000 pixels, respectively.

The sampling system counter sequentially counts the cycle of the sampling clock signal input from the feedback circuit 1113. The sampling system counter generates a sampling reset signal having a predetermined positive voltage value and resets the count value to 0 when the count value obtained by counting is equal to the number of scanning pixels. Then, the sampling system counter outputs the generated sampling reset signal to the feedback circuit 1113.

The amplifier 1115 amplifies the voltage value of the driving pulse signal input from the driving pulse generating circuit 1114 with a predetermined amplification factor. The amplifier 1115 outputs the driving pulse signal obtained by amplifying the voltage value to the driving coil. The driving pulse signal has predetermined positive signal values and negative signal values in the ¼ period and the ¾ period of the scanning period, respectively. Therefore, the driving coil is driven at the midpoint of each of the outward and return paths.

As described above, the image input device 1 according to the present embodiment includes a scanning unit 11 that reciprocates the scanning point at which light from the light source enters the surface of the sample and outputs a scanning period end signal indicating the end of the reciprocating scanning period. The image input device 1 includes a scanning signal obtaining unit 123 that obtains an outward path scanning signal indicating the intensity of reflected light from a scan point in the outward path and a return path scanning signal indicating the intensity of reflected light from the scan point in the return path. The image input device 1 includes an image generating unit 13 that obtains the shift amount between the outward path scanning signal and the return path scanning signal based on the scanning period end signal, compensates the shift between the outward path scanning signal and the return path scanning signal based on the obtained shift amount, and generates an image signal using the outward path scanning signal and the return path scanning signal that have been compensated for shift.

With this configuration, the shift amount between the outward path scanning signal and the return path scanning signal obtained according to the end of the reciprocal scanning period is obtained. Also, an image signal is generated using the outward path scanning signal and the return path scanning signal that are compensated for shift based on the obtained shift amount. Therefore, the image input device 1 is able to obtain an image signal showing image whose shift has been compensated for by not obtaining the shift amount in advance using a specific sample or an operation mode but operating in the normal operation mode using the normal observation sample.

### Second Embodiment

Next, a second embodiment of the present invention will be described. The same reference numerals are given to the same configurations as those of the above-described embodiment, and the description thereof is incorporated by reference.

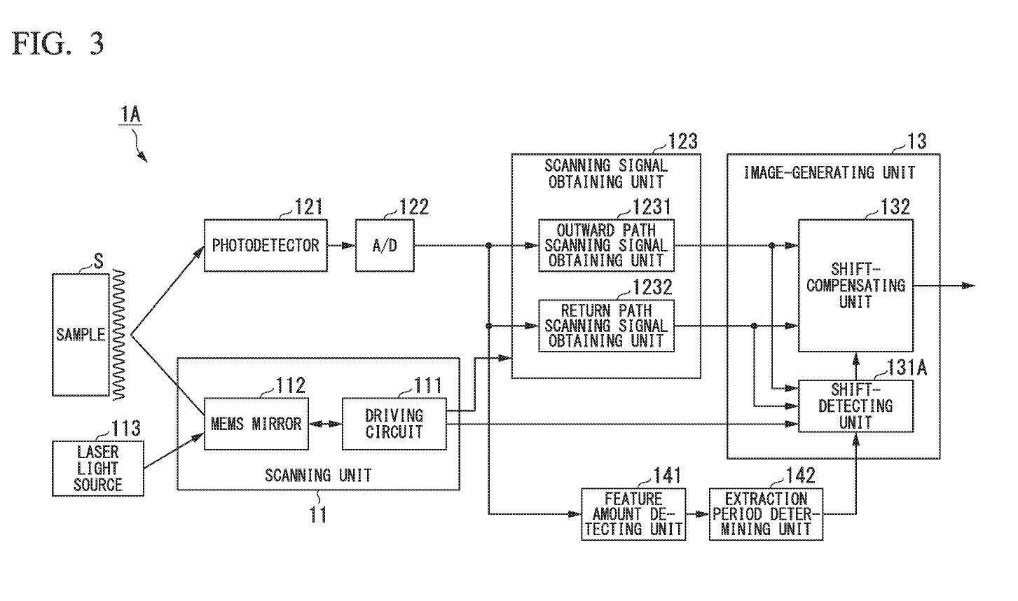

FIG. 3 is a schematic block diagram showing a configuration example of the image input device 1A according to the present embodiment. The image input device 1A includes the shift-detecting unit 131A instead of the shift-detecting unit 131 of the image input device 1 (FIG. 1), and further includes a feature amount detecting unit 141 and an extraction period determining unit 142.

The feature amount detecting unit 141A calculates a feature amount for each block of a predetermined size from the scanning signal input from the A/D 122. The size of the block is preset in the feature amount detecting unit 141. The size of the block may be a section that is sufficiently shorter than each one scanning. The feature amount is a high-range component amount representing the amount of a high-frequency component whose frequency is higher than a predetermined cutoff frequency. The feature amount detecting unit 141 is configured to include an HPF (high pass filter) and an integrating circuit. The HPF passes through a high frequency component of the scanning signal whose frequency is higher than a predetermined cutoff frequency to generate an HPF signal. The integrating circuit integrates the voltage value of the HPF signal for each block and calculates the integrated value obtained by the integration as the high frequency component amount. The integration circuit outputs a high-frequency component amount signal indicating the high-frequency component amount calculated for each block to the extraction period determining unit 142.

The extraction period determining unit 142 selects an extraction period for a block in which the high-frequency component amount of each block indicated by the high-frequency component signal input from the feature amount detecting unit 141 is larger than a predetermined amount. The extraction period determining unit 142 selects, for example, a block having the largest high-frequency component amount among outward path scanning signals of each frame. The extraction period determining unit 142 outputs the extraction period signal indicating the selected extraction period to the shift-detecting unit 131A.

The shift-detecting unit 131A performs block matching between the outward path scanning signal within the extraction period indicated by the extraction period signal input from the extraction period determining unit 142 and the return scanning period of the return path immediately after that. The processing unit for block matching is equal to the unit for which the extraction period determining unit 142 selects the extraction period. In the example described above, the shift-detecting unit 131A performs block matching for each frame. The shift-detecting unit 131A outputs a shift amount signal indicating the shift amount obtained by performing block matching to the shift-compensating unit 132.

Next, an example of execution of the image input processing according to the present embodiment will be described.

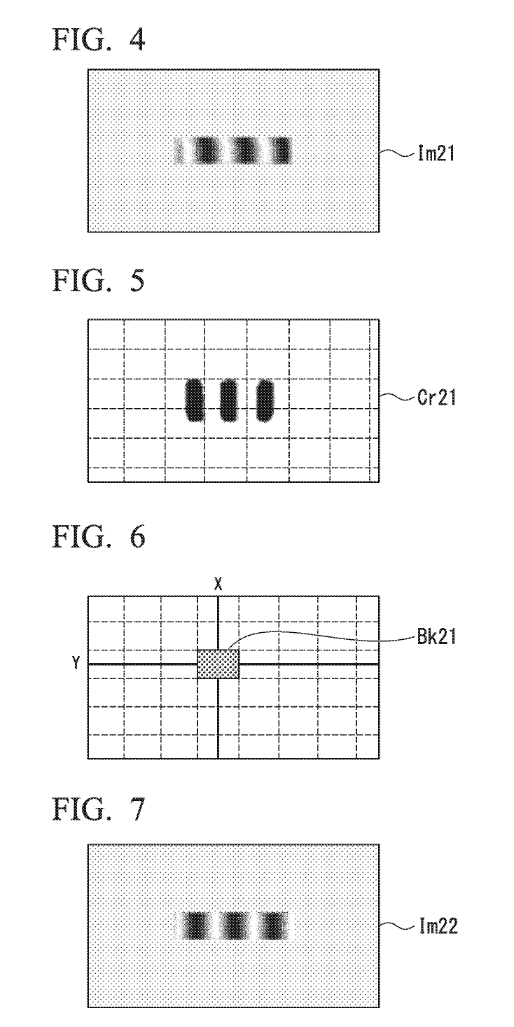

FIG. 4 is a diagram showing an example (image Im21) of an image based on the scanning signal. The image Im21 is an image representing the state of the surface of the sample S having a regular pattern in the horizontal direction. The image signal representing the image Im21 is an image signal generated by alternately accumulating the outward path scanning signal and the return path scanning signal forming the scanning signal output from the A/D 122 without performing the shift compensation. The image Im21 represents a vertical striped pattern having a shading boundary in the vertical direction at the center portion thereof. These boundaries are blurred because of the shift between the outward path scanning signal and return path scanning signal occurring between the lines.

FIG. 5 is a diagram showing an example (image Cr21) of an image based on the HPF signal. The image Cr21 is an image signal generated by alternately accumulating the signal in the outward path section and the signal in the return section of the HPF signal generated by the feature amount detecting unit 141 without performing the shift compensation. This HPF signal is a signal obtained by passing the HPF through the scanning signal used for generating the image signal representing the image Im21 The image Cr21 represents a vertical stripe pattern having a shading boundary in the vertical direction at the center portion thereof. The signal value is larger for the darker portion, and the signal value is smaller for the brightly expressed portion. That is, the image Cr21 indicates that, in the section corresponding to the vertical striped pattern portion of the scanning signal indicated by the image Im21, the high-frequency component in the horizontal direction is main. Individual areas delimited by dashed lines indicate blocks. For each block, the high-frequency component amount is obtained by the feature amount detecting unit 141.

FIG. 6 is a diagram showing an example (block Bk21) of the selected block. In the example shown in FIG. 6, the block is a rectangular region delimited by a broken line. The block Bk21 is a block in which the feature amount for each block obtained based on the HPF signal on the image Cr21 among the blocks belonging to the line Y is the maximum in the extraction period determining unit 142. X indicates the coordinate in the horizontal direction of the block Bk21. In the example shown in FIG. 6, it is shown that the period of the scanning signal related to the block Bk21 including the largest number of regions in which the high-frequency component is dominant is selected as the extraction period. The outward scanning signal within the selected extraction period is used for block matching with the subsequent return path scanning signal in the shift detecting unit 131A.

FIG. 7 is a diagram showing an example (image Im22) of the image represented by the image signal subjected to the shift compensation. The image Im22 is an image indicated by an image signal obtained by sequentially accumulating the outward path scanning signal and the return path scanning signal related to the image Im21 by performing the shift compensation between the outward path scanning signal and the return path scanning signal in the shift-compensating unit 132. In the shift compensation, the shift amount obtained by block matching between the outward path scanning signal and the return path scanning signal within the extraction period by the shift-detecting unit 131A is used. The outward path scanning signal within the extraction period includes more high frequency components than other periods. This means that the image indicated by the outward path scanning signal in the extraction period is in focus more than the image indicated by the outward path scanning signal in other periods and represents a fine pattern on the sample. Therefore, the shift-detecting unit 131A is able to calculate the similarity with the return path scanning signal with high accuracy in block matching. The boundary of the shading of the vertical stripe pattern possessed by the image Im22 is sharper than that by the image Im21 This indicates that image quality is improved by compensation based on the shift amount detected with high accuracy.

As described above, the image input device 1A according to the present embodiment includes a feature amount detecting unit 141 that detects a feature amount indicating the amount of high frequency components whose frequency is higher than a predetermined frequency from the outward path scanning signal. The image input device 1A further includes an extraction period determining unit 142 that determines an extraction period in which the amount of the high-frequency component indicated by the feature amount is larger than a predetermined amount.

With this configuration, the shift detecting unit 131A obtains the shift amount of the outward path scanning signal with respect to the return path scanning signal, using the outward path scanning signal within the extraction period in which the amount of high frequency components is large. Since the outward path scanning signal within the extraction period in which the amount of the high frequency component is large represents an image having a fine pattern on the surface of the sample, the shift detecting unit 131A is able to obtain the shift amount with high accuracy. Therefore, the shift-compensating unit 132 is able to compensate the shift between the outward path scanning signal and the return path scanning signal using the shift amount obtained with high accuracy, and obtain the image signal representing the image of high image quality.

### Third Embodiment

Next, a third embodiment of the present invention will be described. The same reference numerals are given to the same configurations as those of the above-described embodiment, and the description thereof is incorporated by reference.

The shift-detecting unit 131A (FIG. 3) of the image input device 1A performs block matching between the outward path scanning signal and the return path scanning signal within the extraction period in which the high-frequency component of the scanning signal is predominant. Since the index value indicating the similarity between images in the block matching processing also fluctuates in a certain cycle, with respect to the image in which the high periodicity is dominant in the high region, a shift amount that is an integral multiple of the cycle, for example, one cycle, may be detected rather than a true shift amount. An image of such a sample includes, for example, a wiring pattern of a semiconductor chip regularly applied on its surface.

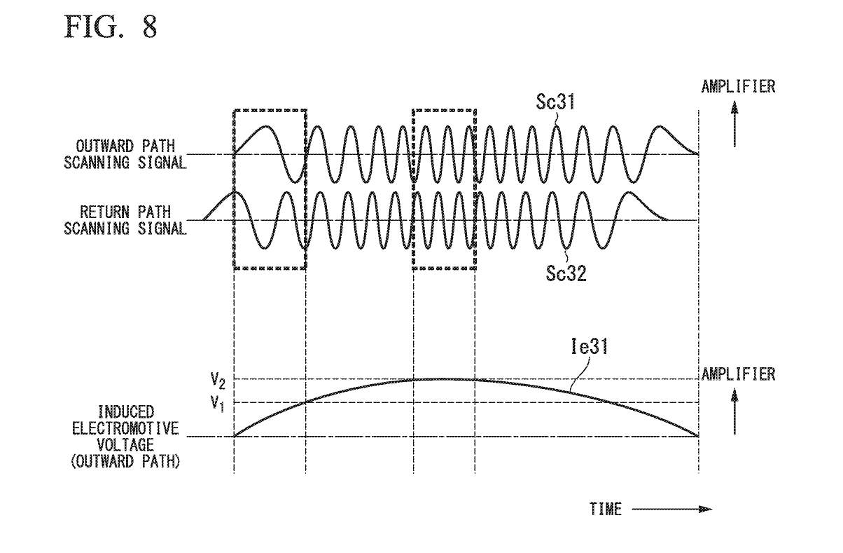

On the other hand, in the scanning by the resonant motion of the MEMS mirror 112, the scanning speed is a sine function with respect to time. The scanning speed is detected as the induced electromotive voltage of the induced electromotive voltage signal. When the specimen is a lattice pattern having a period, as shown in FIG. 8, the scanning speed immediately after the start of scanning and immediately before the end of scanning is lower than the other periods. Therefore, the period of the signal value of the scanning signal becomes longer than the other period immediately after the start of scanning and immediately before the end of scanning, and becomes the shortest in the central part. Also, the tendency of the cycle of the signal value to become shorter as time elapses immediately after the start of scanning and the tendency of the cycle of the signal value to become longer as time elapses just before the end of the scanning are more significant than in the central portion.

The shift-detecting unit 131B of the image input device 1B according to the present embodiment uses this characteristic to more accurately detect the shift amount.

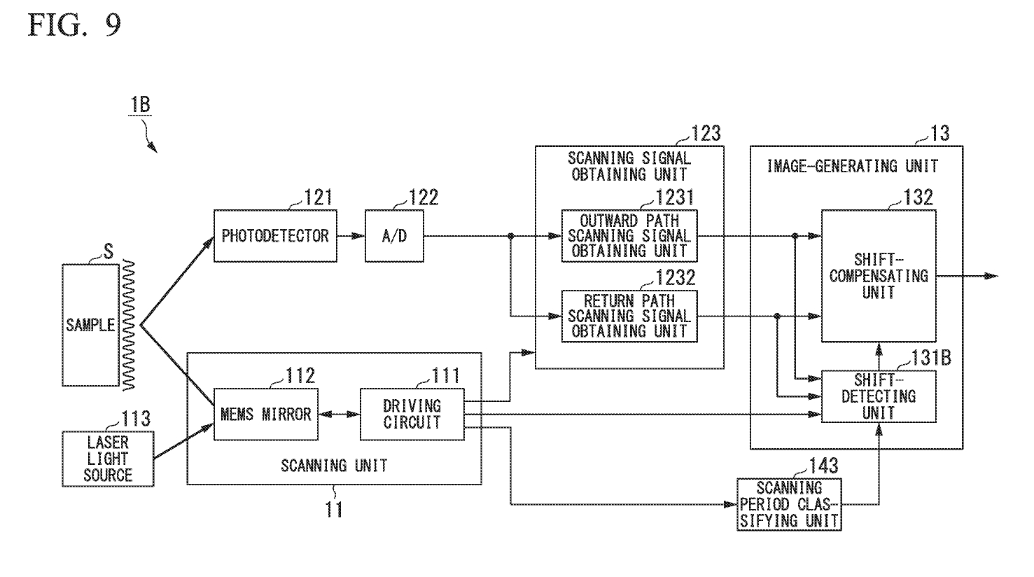

FIG. 9 is a schematic block diagram showing a configuration example of the image input device 1B according to the present embodiment. The image input device 1B includes the shift-detecting unit 131B instead of the shift-detecting unit 131 for the image input device 1 (FIG. 1), and further includes a scanning period classifying unit 143.

The scanning period classifying unit 143 defines a period in which the induced electromotive voltage indicated by the induced electromotive voltage signal input from the induced electromotive voltage detecting circuit 1111 (FIG. 2) of the driving circuit 111 is lower than a predetermined induced electromotive voltage as a low speed period. In the example shown in FIG. 8, a period in which the induced electromotive voltage Ie31 is lower than the predetermined induced electromotive voltage v1 is determined as the low speed period. The low speed period corresponds to a predetermined period from the start of scanning of each of the outward path scanning signal Sc31 and the return path scanning signal Sc32 to a predetermined period from the start of scanning to the end of scanning. Note that the scanning period classifying unit 143 may determine a low-speed period in units equal to the processing unit of block matching performed by the shift-detecting unit 131B, for example, every round-trip each time. Here, the scanning period classifying unit 143 may define a low speed period in the outward period scanning signal, selected from either one of a predetermined period from the start of one scanning and a predetermined period to the end of the operation, for example, only a predetermined period from the start of scanning. The scanning period classifying unit 143 outputs the classification signal indicating the determined low speed period to the shift-detecting unit 131B.

The shift-detecting unit 131B performs the above-described block matching on the outward path scanning signal and the return path scanning signal within the low speed period indicated by the classification signal input from the scanning period classifying unit 143. The shift-detecting unit 131B outputs a shift amount signal indicating the shift amount obtained by performing block matching to the shift-compensating unit 132.

Since the periodicity of the signal value is low within the low speed period, the periodicity of the fluctuation of the index value indicating the similarity between images in the block matching processing also becomes low. Therefore, in the sample S having a pattern with high periodicity, it is possible to avoid erroneous detection of the shift amount shifted by an integer period from the original shift amount.

As described above, the image input device 1B according to the present embodiment includes the scanning period classifying unit 143 that determines a low speed period, which is a period in which the scanning speed is lower than the predetermined scanning speed. Further, the shift-detecting unit 131B calculates the shift amount between the outward path scanning signal and the return path scanning signal in the low speed period.

With this configuration, the shift detecting unit 131B obtains the shift amount between the outward path scanning signal and the return path scanning signal within the low speed period in which periodicity is impaired. Therefore, even when the outward path scanning signal and the return path scanning signal represent an image having periodicity on the surface of the sample, it is possible to avoid erroneously obtaining a shift amount shifted by an integral multiple of the cycle. Therefore, the shift-compensating unit 132 is able to compensate the shift between the outward path scanning signal and the return path scanning signal using the correctly obtained shift amount, and obtain the image signal representing the image of high image quality.

### Fourth Embodiment

Next, a fourth embodiment of the present invention will be described. The same reference numerals are given to the same configurations as those of the above-described embodiment, and the description thereof is incorporated by reference.

The shift-detecting unit 131B (FIG. 9) of the image input device 1B performs block matching with the outward path scanning signal and the return path scanning signal within the low speed period when the periodicity is low. However, in the low speed period, the shift detection resolution becomes lower than the high speed period. This is because, in the shift detection, since the change of the index value indicating the similarity between the outward path scanning signal and the return path scanning signal with respect to the shift amount candidate is gentler in the low speed period than in the high speed period, the error of the index value due to the noise increases. Regarding this point, although it is conceivable that the A/D 122 makes the sampling period variable, in the image input device 1C according to the present embodiment, the shift-detecting unit 131C uses this characteristic to detect the shift amount with high precision.

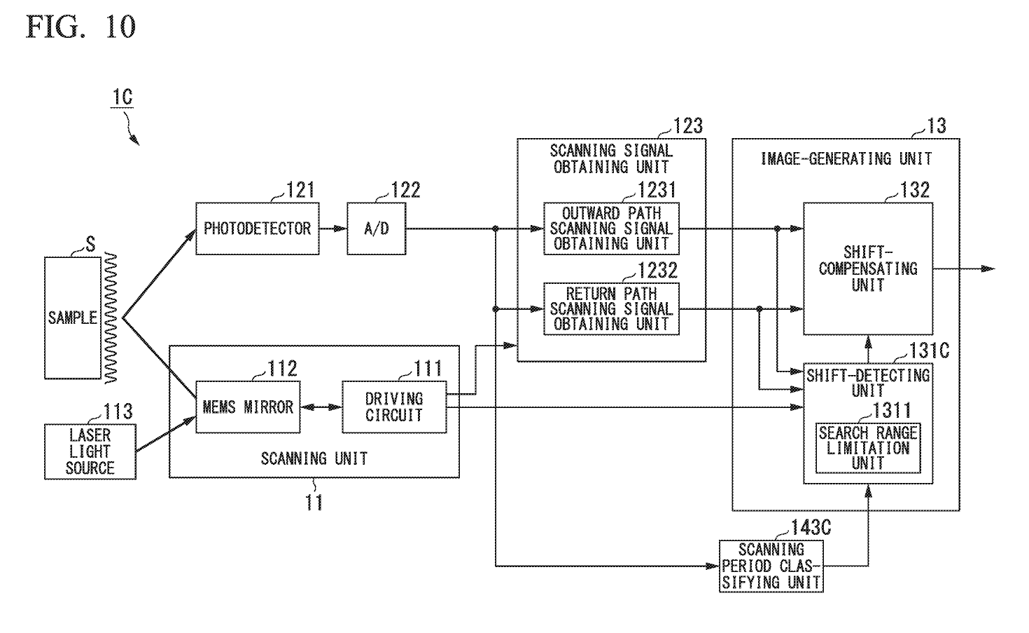

FIG. 10 is a schematic block diagram showing a configuration example of the image input device 1C according to the present embodiment. The image input device 1C includes the shift-detecting unit 131C and the scanning period classifying unit 143C instead of the shift-detecting unit 131B and the scanning period classifying unit 143 with respect to the image input device 1B (FIG. 9).

Similarly to the scanning period classifying unit 143, the scanning period classifying unit 143C determines a period in which the induced electromotive voltage indicated by the induced electromotive voltage signal is lower than a predetermined first induced electromotive voltage as a low speed period, and determines a period in which the induced electromotive voltage is higher than a predetermined second induced electromotive voltage as a high-speed period. The second induced electromotive voltage may be equal to the first induced electromotive voltage or higher than the first induced electromotive voltage unless it exceeds the maximum value of the induced electromotive voltage indicated by the induced electromotive voltage signal. In addition, the scanning period classifying unit 143C may determine the high-speed period in the same processing unit as the low-speed period.

In the example shown in FIG. 8, a period during which the induced electromotive voltage Ie31 is higher than the second induced electromotive voltage v2 is determined as the high-speed period. The high-speed period is a period corresponding to the central portion including the midpoints of the outward path scanning signal Sc31 and the return path scanning signal Sc32. The scanning period classifying unit 143 outputs classification signals indicating the determined low speed period and high speed period to the shift-detecting unit 131C.

The shift-detecting unit 131C performs the block matching process described above between the outward path scanning signal and the return path scanning signal within the low speed period indicated by the classification signal input from the scanning period classifying unit 143. The shift-detecting unit 131C includes a search range limitation unit 1311 that limits the search range within a predetermined pixel number range with the shift amount obtained by the block matching process within the low speed period as the center. The shift detecting unit 131C performs block matching processing between the outward path scanning signal in the high speed period indicated by the classification signal and the return scanning period. In this block matching process, the shift-detecting unit 131C calculates an index value indicating similarity between the outward path scanning signal and the return path scanning signal within the high-speed period for each of the shift amount candidates within the search range determined by the search range limitation unit 1311. The shift-detecting unit 131C determines the shift amount candidate having the smallest calculated index value as the shift amount between the outward path scanning signal and the return path scanning signal in the high speed period. The shift detecting unit 131C outputs a shift amount signal indicating the determined shift amount to the shift-compensating unit 132.

### (Shift Detection Process)

Next, the shift detection processing according to the present embodiment will be described.

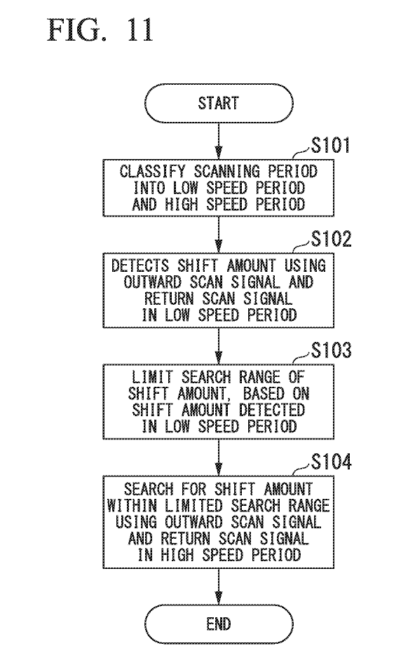

FIG. 11 is a flowchart showing the shift detection process according to this embodiment.

### (Step S101)

The scanning period classifying unit 143C determines a period in which the induced electromotive voltage indicated by the induced electromotive voltage signal from the driving circuit 111 is lower than a predetermined first induced electromotive voltage as a low-speed period, and determines a period in which the induced electromotive voltage indicated is higher than a predetermined second induced electromotive voltage as a high-speed period. Thereafter, the process proceeds to step S102.

### (Step S102)

The shift-detecting unit 131C performs block matching processing between the outward path scanning signal and the return scanning period within the low speed period to detect the shift amount. Thereafter, the process proceeds to step S103.

### (Step S103)

The search range limitation unit 1311 determines a search range limited to a predetermined search range with reference to the shift amount within the low speed period detected in step S102. Thereafter, the process proceeds to step S104.

### (Step S104)

The shift-detecting unit 131C performs block matching processing between the outward path scanning signal and the return path scanning signal in the high-speed period. In the block matching processing, a shift amount that minimizes an index value indicating similarity between the outward path scanning signal and the return path scanning signal within the search range determined in step S104 is searched. Thereafter, the processing of FIG. 11 ends.

As described above, in the image input device 1C according to the present embodiment, the scanning period classification unit 143C further determines a high-speed period in which the scanning speed is higher than the predetermined scanning speed. The shift-detecting unit 131C determines the search range of the shift amount based on the shift amount between the outward path scanning signal and the return path scanning signal in the low speed period. Further, the shift-detecting unit 131C determines the shift amount between the outward path scanning signal and the return path scanning signal in the high-speed period within the determined search range.

With this configuration, the shift-detecting unit 131C determines the search range of the shift amount based on the shift amount between the outward path scanning signal and the return path scanning signal within the low speed period in which periodicity is impaired. Therefore, it is possible to limit the search range based on the shift amount correctly obtained as the search range of the shift amount. Then, the shift-detecting unit 131C determines the shift amount within the search range based on the shift amount between the outward path scanning signal and the return path scanning signal within the high-speed period in which the resolution of the shift detection is high. Therefore, the shift-detecting unit 131C is able to determine the shift amount between the outward path scanning signal and the return path scanning signal with high accuracy. Therefore, the shift-compensating unit 132 is able to compensate the shift between the outward path scanning signal and the return path scanning signal using the obtained high-accuracy shift amount to obtain the image signal representing the image of high image quality.

### Modification Example

Although the embodiments of the present invention have been described above, various modifications can be made without departing from the gist of the present invention.

For example, instead of the MEMS mirror 112, the scanning unit 11 may include other types of mirrors that perform a resonant motion in response to a driving pulse signal, such as a galvano mirror.

The driving pulse signal generated by the driving pulse generating circuit 1114 may be a signal having either one of a predetermined positive voltage value in the ¼ cycle or a predetermined negative voltage value in the ¾ cycle from the start time of each scanning period.

In the block matching, the shift-detecting unit 131 exemplifies a case where the shift amount is determined by shifting the return path scanning signal with reference to the position of the outward path scanning signal, but the present invention is not limited thereto. The shift-detecting unit 131 may shift the outward scanning signal with reference to the position of the return path scanning signal to determine the shift amount.

The extraction period determining unit 142 may determine the extraction period in the return path scanning signal instead of the outward path scanning signal. In that case, the shift-detecting unit 131A shifts the outward scanning signal with reference to the position of the return path scanning signal within the extracting period, and determines the shift amount.

Instead of the outward path scanning signal, the scanning period classifying unit 143, 143C may define a low speed period in the return path scanning signal. In that case, the shift detecting units 131B and 131C shift the outward path scanning signal with the position of the return path scanning signal within the low speed period as a reference and determine the shift amount.

Instead of the outward path scanning signal, the scanning period classifying unit 143C may determine the high-speed period in the return path scanning signal. In that case, the shift-detecting unit 131C shifts the outward path scanning signal with the position of the return path scanning signal within the high-speed period as a reference and determines the shift amount.

Each of the image input devices 1B and 1C may include a feature amount detecting unit 141 and an extraction period determining unit 142. In that case, the scanning period classifying units 143 and 143C determine the low speed period from the scanning signal within the extraction period determined by the extraction period determining unit 142. Further, the scanning period classifying unit 143C determines a high-speed period from the scanning signal within the extraction period determined by the extraction period determining unit 142.

In the image input devices 1, 1A, 1B, 1C, the drive circuit 111, the outward path scanning signal obtaining unit 1231, the return path scanning signal obtaining unit 1232, the shift-detecting units 131, 131A, 131B, 131C, the shift-compensating unit 132, feature amount detecting unit 141, the extraction period determining unit 142, and the scanning period classifying units 143, 143C may be configured as one circuit each, or may be configured as an integrated circuit of a combination of a predetermined combination of a part of them, or a combination of all of them.

Although preferred embodiments of the present invention have been described above, the present invention is not limited to these embodiments and modifications thereof. Additions, omissions, substitutions, and other changes to the configuration can be made without departing from the spirit of the present invention.

Also, the present invention is not limited by the foregoing description, but is limited only by the scope of the appended claims.

What is claimed is:

1. An image input device comprising:
a scanning unit that moves a scanning point, which is a point where light from a light source is incident on a surface of a sample, in a reciprocating manner, and outputs a scanning period end signal that represents ending of a reciprocating scanning period;
a scanning signal obtaining unit that obtains an outward path scanning signal that represents an intensity of light reflected from the scanning point along an outward path, and a return path scanning signal that represents an intensity of light reflected from the scanning point along a return path;
a feature amount detecting unit that detects a feature amount from one of the outward path scanning signal and the return path scanning signal, the feature amount representing an amount of a high-frequency component which is a component whose frequency is higher than a predetermined frequency;
an extraction period determining unit that determines an extraction period in which an amount of the high-frequency component indicated by the feature amount is larger than a predetermined amount; and
an image-generating unit that
obtains a shift amount between the outward path scanning signal and the return path scanning signal, using the one of the outward path scanning signal and the return path scanning signal in the extraction period and the other of the outward path scanning signal and the return path scanning signal,
compensates for a shift between the outward path scanning signal and the return path scanning signal, based on the shift amount, and
generates an image signal using the outward path scanning signal and return path scanning signal that have been shift-compensated.

2. The image input device according to claim 1, further comprising:
a period classification unit that determines a low speed period in which a scanning speed is lower than a predetermined scanning speed,
wherein the image-generating unit calculates a shift amount between the outward path scanning signal and the return path scanning signal in the low speed period.

3. The image input device according to claim 2, wherein
the period classification unit determines a high speed period in which the scanning speed is higher than a predetermined scanning speed, and
the image-generating unit determines a search range based on the shift amount in the low speed period, and obtains the shift amount between the outward path scanning signal and the return path scanning signal in the high speed period within the search range.

4. An image input method in an image input device comprising:
a scanning process in which a scanning point, which is a point where light from a light source is incident on a surface of a sample, is moved in a reciprocating manner, and a scanning period end signal that represents ending of a reciprocating scanning period is output;
a scanning signal obtaining process in which an outward path scanning signal that represents an intensity of light reflected from the scanning point along an outward path, and a return path scanning signal that represents an intensity of light reflected from the scanning point along a return path are obtained;
a feature amount detecting process in which a feature amount is detected from one of the outward path scanning signal and the return path scanning signal, the feature amount representing an amount of a high-frequency component which is a component whose frequency is higher than a predetermined frequency;
an extraction period determining process in which an extraction period in which an amount of the high-frequency component indicated by the feature amount is larger than a predetermined amount is determined; and
an image-generating process in which
a shift amount between the outward path scanning signal and the return path scanning signal is obtained, using the one of the outward path scanning signal and the return path scanning signal in the extraction period and the other of the outward path scanning signal and the return path scanning signal,
a shift between the outward path scanning signal and the return path scanning signal is compensated for, based on the shift amount, and
an image signal is generated, using the outward path scanning signal and return path scanning signal that have been shift-compensated.
